(19) United States
(12) Patent Application Publication
(10) Pub. No.: US 2016/0224569 A1
(43) Pub. Date: Aug. 4, 2016

(54) SYSTEM AND METHOD FOR AUTOMATICALLY PUBLISHING A WEB FORM FROM A SEMANTIC QUERY

(71) Applicant: General Electric Company, Schenectady, NY (US)

(72) Inventors: Paul Edward Cuddihy, Ballston Lake, NY (US); Ravi Kiran Reddy Palla, Glenville, NY (US); Justin DeSpenza McHugh, Latham, NY (US)

(21) Appl. No.: 14/613,075

(22) Filed: Feb. 3, 2015

(51) Int. Cl. G06F 17/30; G06F 3/0482; G06F 3/0484; G06F 17/24; G06F 17/22

(52) U.S. Cl. CPC G06F 17/3064; G06F 17/30657; G06F 17/243; G06F 17/30699; G06F 17/2247; G06F 3/0484; G06F 3/0482; G06F 17/30312

(57) ABSTRACT

A method includes storing a database search query for searching a semantic database. The database search query includes references to a plurality of data classes. The data classes correspond to data stored in the semantic database. The database search query includes a plurality of filter values and a plurality of return values. Relationship data is stored in association with the stored database search query. The relationship data indicates relationships among data classes included in the plurality of data classes. A data entry form is automatically generated. The data entry form includes a respective data entry mechanism that corresponds to each filter value included in the database search query. The data entry form also includes a respective data display column that corresponds to each return variable. A respective set of permissible input values is automatically generated for each of the data entry mechanisms.

### BACKGROUND

1. Technical Field

Embodiments of the invention relate to semantic database searching.

2. Discussion of Art

Semantic databases are well-known. Such databases may be built from a conceptual data model that specifies relationships among data objects.

The users of semantic databases typically are experts in the subject matter (sometimes called the “domain”) to which the data relates. Typically such users do not have expert knowledge about how databases are constructed nor are they typically versed in the particular framework of relationships (sometimes called an “ontology”) among data classes that was used to build the database they wish to search. They may also not be familiar with formal requirements for composing valid search queries. Therefore, database users may sometimes need to pursue the potentially inconvenient process of consulting with an expert in the design of the database in order to obtain desired information from the database.

In U.S. patent application Ser. No. 14/572,225; filed Dec. 16, 2014; the present inventors have disclosed a graphically-based tool for automatically generating seach queries based on user interaction with a graphical representation of data class relationships. This tool may aid non-experts in database design in accessing desired data in a semantic database without requiring assistance from an expert in database design.

The present inventors have now recognized opportunities to provide an additional resource for customizing search queries to match an individual user's needs, without requiring the user to have either database design expertise or domain expertise.

### BRIEF DESCRIPTION

In some embodiments, a method includes storing a database search query for searching a semantic database. The database search query may include references to a plurality of data classes that correspond to data stored in the semantic database. The database search query may include a plurality of filter values and a plurality of return variables. The method may further include storing relationship data in association with the stored database search query. The relationship data may be indicative of relationships among data classes included in the plurality of data classes referenced by the stored search query. The method may also include automatically generating a data entry form that includes a respective data entry mechanism that corresponds to each filter value included in the stored search query. The data entry form may also include a respective data display column that corresponds to each return variable. Moreover, the method may include automatically generating a respective set of permissible input values for each of the data entry mechanisms.

In some embodiments, an apparatus includes a processor and a memory in communication with the processor. The memory stores program instructions, and the processor is operative with the program instructions to perform functions as set forth in the preceding paragraph.

### BRIEF DESCRIPTION OF THE DRAWINGS

FIG. 1 is a block diagram of a computing system according to some embodiments.

FIG. 2 is a flow diagram of an operation according to some embodiments.

FIG. 3 is an example screen display that may be provided according to some embodiments.

FIGS. 4 and 5 are flow diagrams of operations according to some embodiments.

FIG. 6 shows an example modified search query according to some embodiments.

FIG. 7 is a flow diagram of an operation according to some embodiments.

FIGS. 8 and 9 are example screen displays according to some embodiments.

FIG. 10 is an example search query according to some embodiments.

FIG. 11 is an example screen display according to some embodiments.

FIGS. 12 and 13 are flow diagrams of operations according to some embodiments.

FIG. 14 is a diagram that illustrates a simple example semantic ontology.

FIGS. 15 and 16 are example screen displays that may be provided according to some embodiments.

FIG. 17 is a flow diagram that shows some details of the operation of FIG. 2.

FIGS. 18-21 are further example screen displays that may be provided according to some embodiments.

FIG. 22 is a block diagram of a computing system according to some embodiments.

### DESCRIPTION

Some embodiments of the invention relate to database searching, and more particularly to automatic generation of search queries to be applied to a semantic database. A pre-existing search query may be parsed by a query generation tool. From the results of parsing the pre-existing search query, the tool may generate a data entry form to be presented to a user to allow the user to customize a variation on the pre-existing search query. Based on user input into the data entry screen, the tool may automatically generate the user's desired customization of the pre-existing search query. The user may initiate a search of the database in accordance with the customized search query generated by the tool.

In connection with generating the data entry form, the tool may also perform trial executions of modified versions of the pre-existing search query to generate sets of permissible values for filter parameters included in the pre-existing search query.

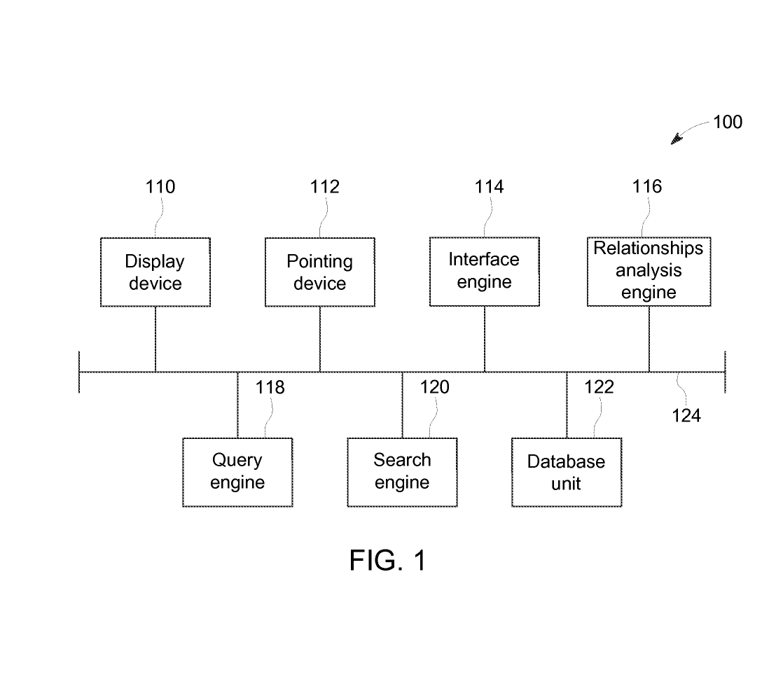

FIG. 1 represents a logical architecture for describing systems, while other implementations may include more or different components arranged in other manners. In FIG. 1, a system 100 includes a display device 110, which may be a conventional computer system display component such as a flat panel display. In addition, the system 100 includes a pointing device 112, such as a conventional computer mouse.

Still further, the system 100 includes an interface engine 114. The interface engine 114 may include hardware and/or software resources to cause a graphical user interface (GUI) to be displayed on the display device 110 in accordance with some embodiments including, e.g., example embodiments described herein. The interface engine 114 also engages in receiving input from a user (not shown) of the system 100 based on the user's interactions with the interface displays provided by the interface engine 114.

Moreover, the system 100 includes a relationships analysis engine 116. The relationships analysis engine 116 may include hardware and/or software resources that respond to input received via the interface engine 114. As will be described further below, the relationships analysis engine 116 may analyze data class relationships among data classes that correspond to a semantic database that is stored in the system 100.

The system 100 also includes a query engine 118. The query engine 118 may include hardware and/or software resources of the system 100. The query engine may respond to user input received via the interface engine 114 to automatically generate a database search query that reflects user interaction via the GUI with a data entry screen displayed on the display device 110. The query engine may use the user input to customize a search query so that it will return data that the user has indicated is of interest.

Also included in the system 100 is a search engine 120. The search engine 120 may include hardware and/or software resources of the system 100. The search engine may apply the search query generated by the query engine 118 to the semantic database to find return data specified by the search query.

The system 100 further includes a database unit 122, which may include hardware and/or software resources of the system 100. In some embodiments, the database unit 122 may operate in a substantially conventional manner relative to storage and retrieval of information in and from a semantic database. It will be noted, however, that the generation of the search queries to be applied to the database unit 122 may be accomplished in accordance with embodiments hereof. The database unit 122 may include, for example, any one or more data storage devices that are or become known. Examples of data storage devices include, but are not limited to, a fixed disk, an array of fixed disks, and volatile memory (e.g., Random Access Memory).

Also, the system 100 includes a communication infrastructure 124. The communication infrastructure 124 is shown as providing operational connections among the other components shown in FIG. 1 and enumerated above. The communication infrastructure 124 may, for example, include one or more data buses and/or facilities for communications among software components.

In some embodiments, one or more of the components 114, 116, 118 and 120 may be constituted by dedicated and/or hardwired hardware processing units and/or by software components operating on conventional general purpose computer hardware.

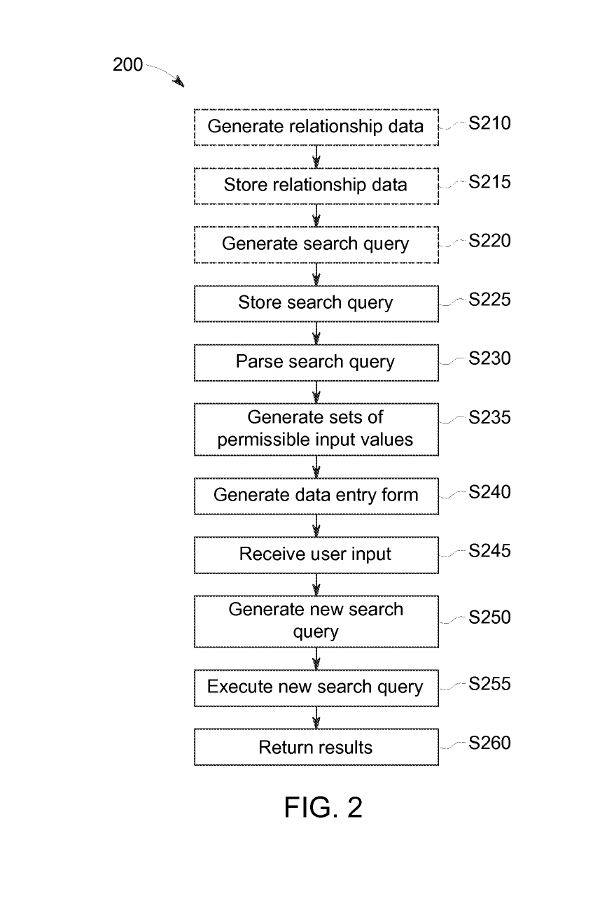

FIG. 2 is a flow diagram of a process 200 according to some embodiments. In some embodiments, various hardware elements (e.g., a processor) of the system 100 execute program code to perform that process and/or the processes illustrated in other flow diagrams. The process and other processes mentioned herein may be embodied in processor-executable program code read from one or more non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

At S210, data relating to relationships represented by the ontology of the semantic database may be generated. This may be done manually, for example, during construction of the semantic database, or alternatively may result from operation of the graphically-based search query tool referred to below. It will be appreciated that these relationships are among data classes represented in the semantic database.

At S215, the data class relationship data is stored in the system 100.

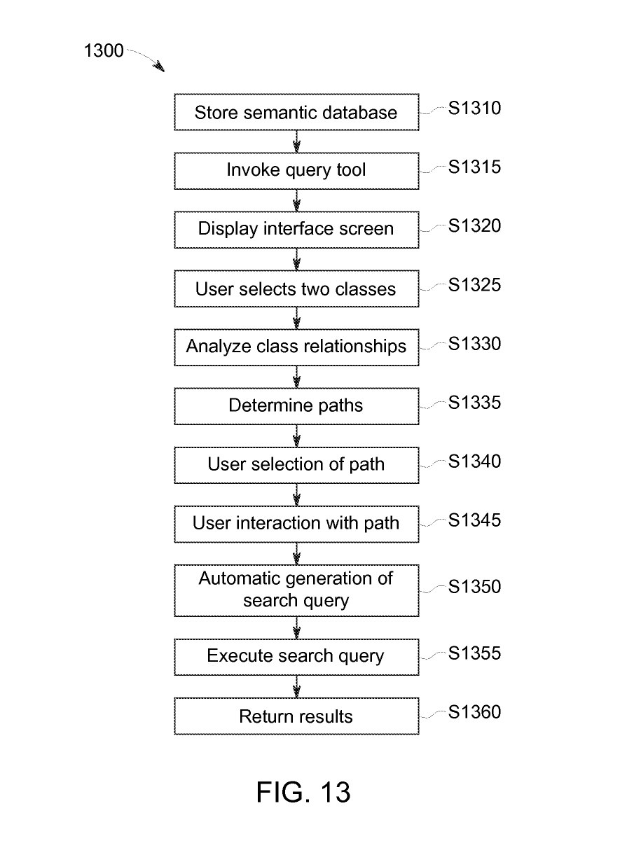

As another initial or preliminary portion of the process 200, a search query may be generated, at step S220. In some embodiments, the search query may have been written manually by an expert in database design, in consultation with a domain expert. In other embodiments, the search query may have been generated by using a graphically-based tool, e.g., as described below with reference to FIGS. 13-21. In still other embodiments, the search query may have been generated in another manner besides those mentioned above. In any case, assuming that a search query exists, it may be stored in the system 100, as indicated at step S225.

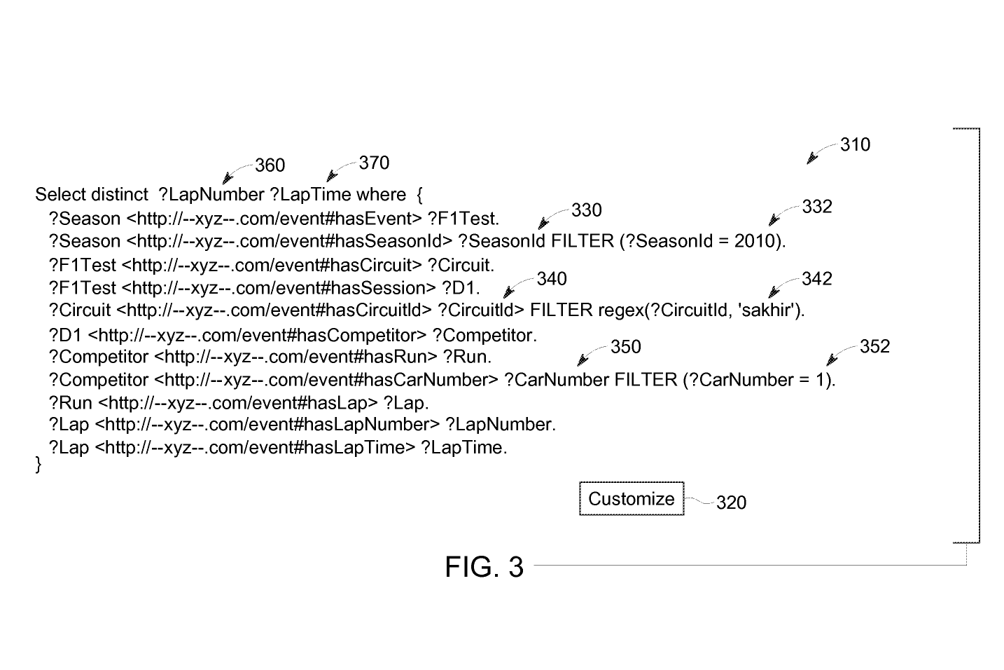

At S230, the system 100 parses the search query that was stored at S215. FIG. 3 is an example screen display provided by the system 100 and showing an example search query 310 that may be parsed at S230. The user may interact with the screen display of FIG. 3 by actuating the virtual button 320 (a “customize” button) shown in the drawing. Actuation of the customize button 320 may launch step S230 and subsequent steps that result in a version of the search query 310 being customized according to input from the user, and in a manner that is user-friendly and does not require expertise on the part of the user. For example, the user may not be either a database design expert or a domain expert, and may have been trained very briefly (if at all) in how to operate the search query customization tool illustrated in FIGS. 2-12. In some embodiments, the search query 310 may have been provided to the user by a more knowledgeable colleague such as a domain expert or a database design expert.

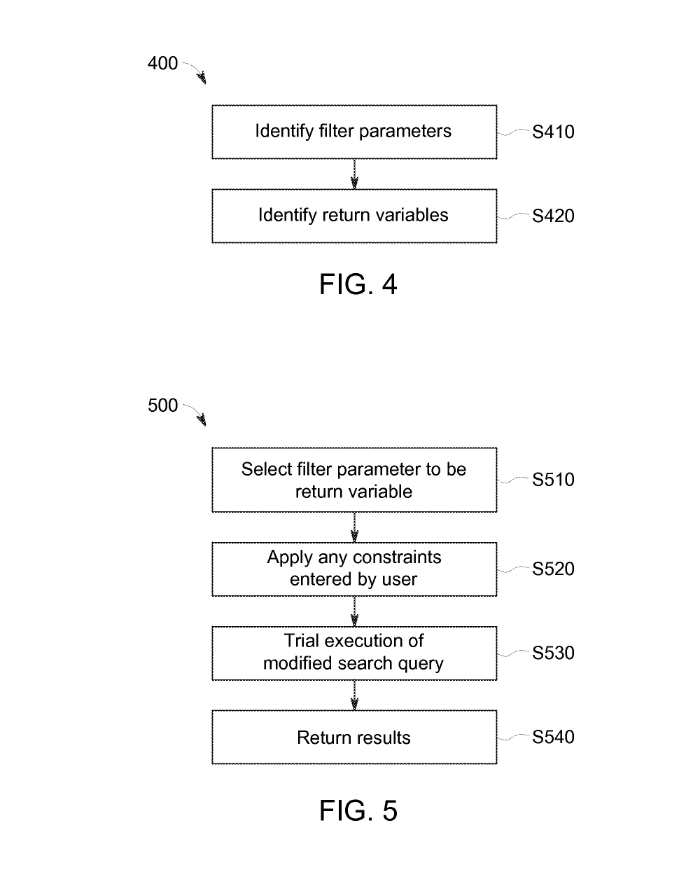

Details of step S230 are illustrated by process 400 shown in FIG. 4. At 410 in FIG. 4, the system 100 identifies the filter parameters contained in the search query that is being parsed. In the example search query shown in FIG. 3, the filter parameters are indicated at 330 (“Seasonld”), 340 (“Circuitld”) and 350 (“CarNumber”). The corresponding filter values in the example search query are shown at 332, 342 and 352, respectively.

Referring again to FIG. 4, at S420, the system 100 identifies the return variables in the search query that is being parsed. In the example search query shown in FIG. 3, the return variables are indicated at 360 (“LapNumber”) and 370 (“LapTime”).

Referring again to FIG. 2, at S235 the system 100 generates a set of permissible input values for each of the filter parameters identified at S410 in FIG. 4. In some alternative embodiments, the generating of sets of permissible input values may not be limited to filter parameters but rather may apply to all variables in the query.

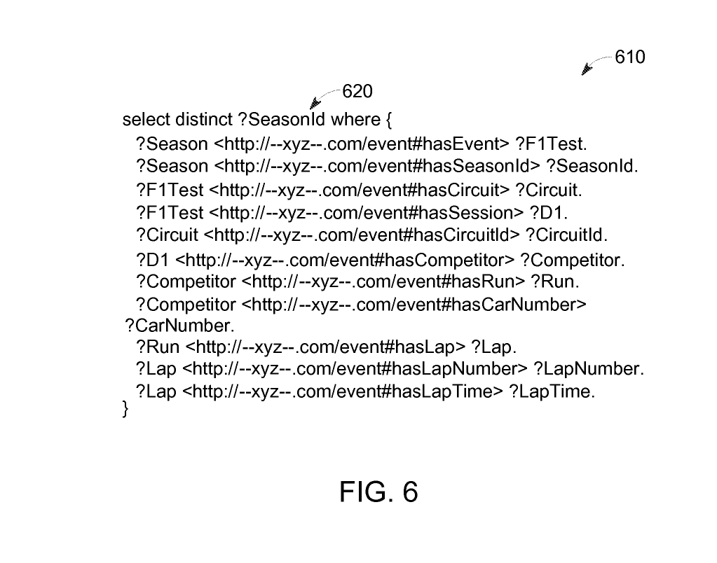

Details of step S235 are illustrated by process 500 shown in FIG. 5. At S510 in FIG. 5, the system 100 selects one of the filter parameters to be a return variable in a modified version of the search query 310 shown in FIG. 3. At S520, the system 100 includes in the modified search query any constraints that the user has already selected for the customized search query that is the goal of the process of FIG. 2. For present purposes, it is assumed that the user has not yet entered any constraints, but at subsequent stages of the process of FIG. 2, after constraints have been entered (as described, for example, in connection with S245), the system 100 may re-execute the process of FIG. 5 to re-determine the set of permissible values for the filter parameters that have not yet been specified. FIG. 6 shows an example modified search query 610, in which the filter parameter 330 seen in FIG. 3 has been selected as the return variable, indicated at 620 in FIG. 6. In this modified search query 610, all constraints have been removed from the search query 310 as shown in FIG. 3. In some alternative embodiments, it may prove to be more efficient to run a subquery rather than the entire modified search query. A subquery may run to completion in a shorter time period but may return some values that do not satisfy the entire query pattern.

At S530 in FIG. 5, the modified search query generated at S510 and S520 (if applicable) is executed as a trial search to generate all of the values of the return variable according to the modified search query. It may be advisable that execution of the modified search query be subject to a time-out function (i.e., a time limit on running the query) and a limit to the number of values to be returned.

The results of the trial search are returned at S540, and constitute the set of permissible values for the filter parameter selected at S510 to be the return variable for the trial search. In connection with the execution of S235 in FIG. 2, the process 500 of FIG. 5 may be performed with respect to each filter parameter identified at S410 in FIG. 4. Accordingly, a respective set of permissible values is generated for each of the filter parameters.

Referring again to FIG. 2, at S240 the system 100 generates a data entry form to be displayed to the user to receive user input for the purpose of customizing the search query stored at S215 and parsed at S230.

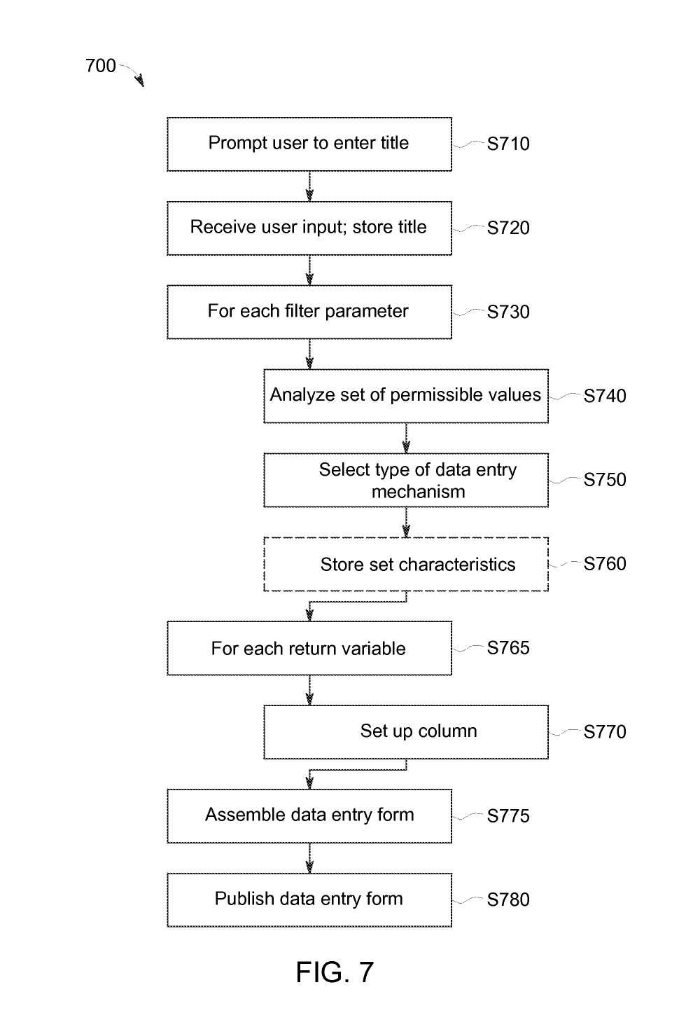

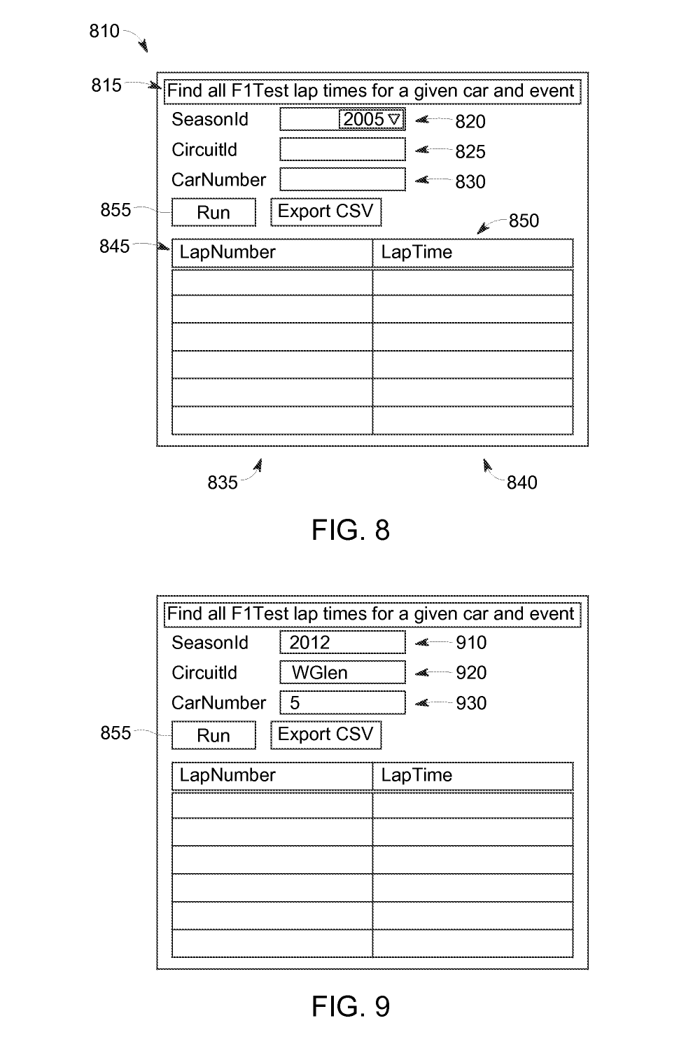

Details of S240 are illustrated by process 700 shown in FIG. 7. FIG. 8 is an example screen display that shows an example data entry form 810 that the system may generate according to some embodiments via the process 700.

At S710 in FIG. 7, the system 100 prompts the user to enter a title for the data entry form 810. It should be understood that the title may also serve as an identifier for the customized search query to be generated via the process of FIG. 2.

Continuing to refer to FIG. 7, at S720, the system 100 receives input from the user to specify the title for the data entry form. In addition, the system 100 stores the title input. For purposes of the current example, it is assumed that the user entered text at S720 that corresponds to the title 815 shown in FIG. 8.

S730 in FIG. 7 indicates that the indented set of blocks that follow S730 in FIG. 7 are to be performed for each of the filter parameters that were identified at S410 in FIG. 4. Thus, for a current one of the filter parameters, at S740, the system 100 analyzes the set of permissible values that was generated for that filter parameter at S235 in FIG. 2. Continuing to refer to FIG. 7, one purpose of analysis at S740 is to determine how many elements (i.e., members) there are in the set of permissible values for the current filter parameter. If the number of permissible values is fairly small (say five or ten such values), then at S750, the system 100 may select the type of data entry mechanism for the current filter parameter to be a menu that lists all the permissible values for that filter parameter. If the number of permissible values of the current is relatively large, then at S750 the system 100 may select the type of data entry mechanism for the current filter parameter to be a free-form data entry field.

Another purpose of the analysis at S740 (e.g., if the number of permissible values is relatively large) may be to analyze the nature of the permissible values, e.g., to determine whether the permissible values are numeric or string values. The results of this analysis may be stored, at S760, in association with the respective filter parameter and/or the respective data entry field.

In some embodiments, the system 100 may offer to the user an opportunity to include an element in the form to specify limits (e.g., both upper and lower limits) on the number of results to be returned in executing the search query to be specified by filling out the form. If the values returned are all strings, a string-matching form element may be generated.

Referring again to FIG. 8, reference numerals 820, 825 and 830 respectively indicate the data entry mechanisms for the three filter parameters identified (in this example) at S410 in FIG. 4. In this example, it is assumed that the data entry mechanism 820 is a menu, while the data entry mechanisms 825 and 830 are free-form data entry fields. It is further assumed that the permissible values to be entered into the data entry mechanism 825 are string values, while the permissible values to be entered into the data entry mechanism 830 are numeric values. Thus the system 100 has included, in the data entry form 810, a respective data entry mechanism for each of the identified filter parameters. When a menu is used as the data entry mechanism, it may be any one of a number of different kinds of menus, including a scrolling selection box, a drop-down menu, etc.

S765 in FIG. 7 indicates that the indented block (i.e., block S770) that follows block S765 is to be performed for each of the return variables that were identified at S420 in FIG. 4. Thus, for the current return variable, at S770, the system 700 sets up a respective return data display column for inclusion in the data entry form 810.

At S775 in FIG. 7, the system 100 assembles the data entry form 810 based on the processing that has previously occurred according to prior steps in the process 700. At S780 the system 100 publishes/displays the data entry form 810 to the user.

Referring again to FIG. 8, it will be observed that the data entry form 810 includes return data display columns 835 and 840, respectively corresponding to the identified return variables (which are presented as column headings 845 and 850 for the columns 835 and 840, respectively).

Continuing to refer to FIG. 8, it will be noted that in this example layout of a data entry form, the form also includes a “run” button 855. The “run” button 855 may be actuated by the user to trigger execution of the customized search query once the entry of filter parameter values is complete. As another option, the user may actuate a button 860 to cause the results of the search to be exported to a CSV (comma separated values) file. In addition, or as an alternative or alternatives, in some embodiments the data entry form 810 may include one or more buttons to allow selection of one or more other data export options, such as to Excel or MATLAB files.

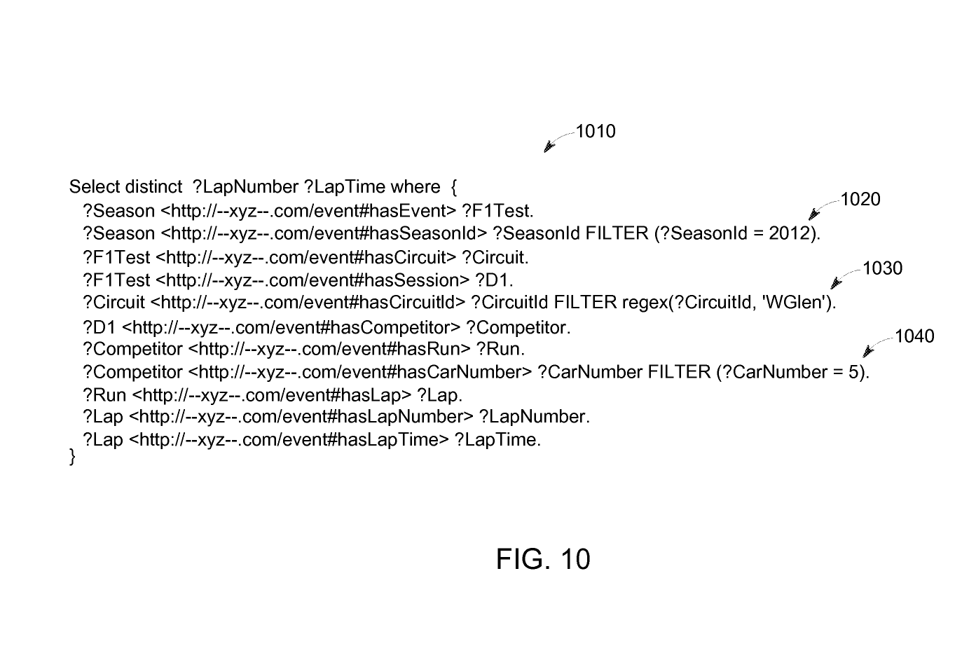

Referring again to FIG. 2, at S245 the system may receive input from the user via the data entry form 810 (FIG. 8). For example, the user may utilize each of the data entry mechanisms 825, 830, 835 to select/enter/specify values for the corresponding filter parameters. FIG. 9 is another view of the data entry form, showing the filter values entered by the user at 910, 920 and 930 The entered parameter values may then serve as constraints in the customized search query generated by the system 100 at S250 (FIG. 2). FIG. 10 shows the resulting example customized search query 1010, with the entered filter parameter values incorporated in the search query at 1020, 1030 and 1040.

In some embodiments, for a data entry mechanism that is a free-form data entry field, when the user inputs a data value into the data entry field, the system 100 may determine whether the input data value is permissible for the corresponding filter parameter. For example, the system 100 may determine whether the input data value is of the correct type (e.g., numeric vs. string) for the data entry mechanism in question. In addition, or alternatively, the system 100 may compare the input data value with each member of the set of permissible values of the corresponding filter parameter, to determine whether the input data value is a member of the set of permissible values. If the system 100 determines that the input data value is not permissible, the system 100 may display a suitable error message to the user. If the input data value is not permissible, but is close to matching one of the permissible values, the system 100 may suggest the latter permissible value to the user.

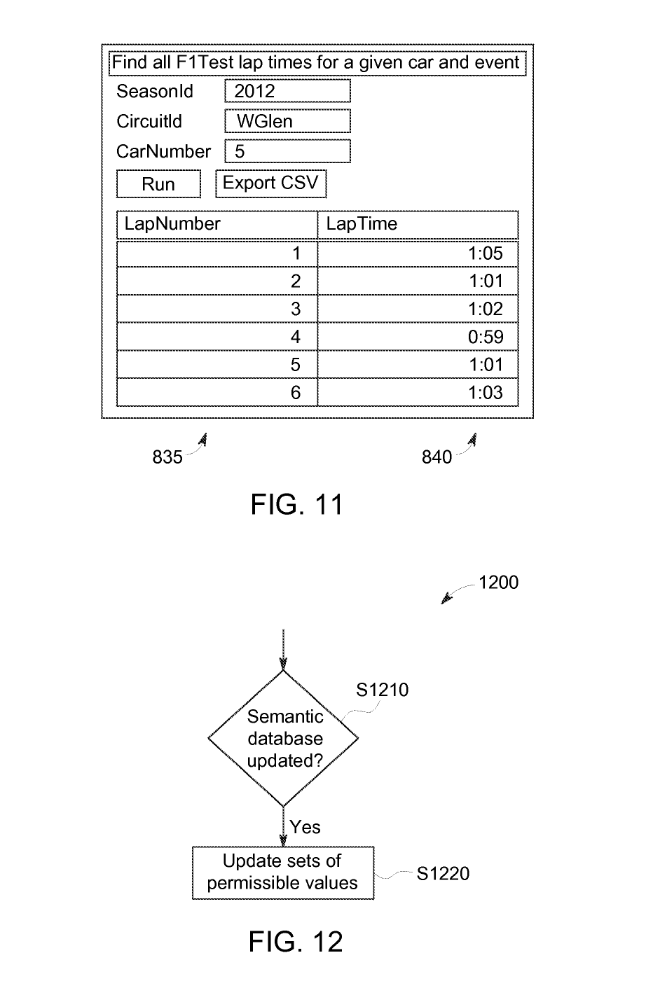

At S255 in FIG. 2, the system 100 may execute the customized search query with respect to the semantic database, e.g., upon the user triggering the search by actuating the ‘run’ button 855 (FIG. 9). At S260, the system 100 may return the results of the search, as shown in columns 835 and 840 in FIG. 11.

With the search query tool illustrated in FIGS. 2-11, an unsophisticated user may customize a search query to retrieve data from a semantic database by entering data into an easily understood data entry form. Consequently, access to data in a semantic database may become much more readily available to users, without the users having to rely on expert assistance.

FIG. 12 illustrates another example feature of the search query tool, i.e., a process 1200 that may run in background in the system 100.

At S1210, the system 100 may determine whether data has been added or removed from the semantic database. If so, then at S1220, the system may update the sets of permissible values for all of the filter parameters for all of the customized search queries generated or to be generated using a data entry form of the type illustrated in FIG. 8. In other words, the system 100 may re-execute S235 (FIG. 2)—when the semantic database is updated—for each previous iteration of the process 200. If appropriate due to changes in a particular set of permissible values for a given filter parameter, the type of the corresponding data entry mechanism may be changed, e.g., from a menu to a free-form data entry field or vice versa.

In some embodiments, the filters are set up when the data entry form is created and may remain essentially static throughout the life of the form, except when new data is added to the semantic database. In other embodiments, the filter mechanisms are populated on the fly each time the user accesses the data entry form. It will be appreciated that the values of one filter may often depend on the values of one or more previously set filters. So if the user constrains a search to one value of a filter variable, the list of permissible values for one or more other filter values may be limited.

FIG. 13 is a flow diagram of a process 1300 according to some embodiments. Process 1300 reflects one possible embodiment of step S210 of process 200 illustrated in FIG. 2.

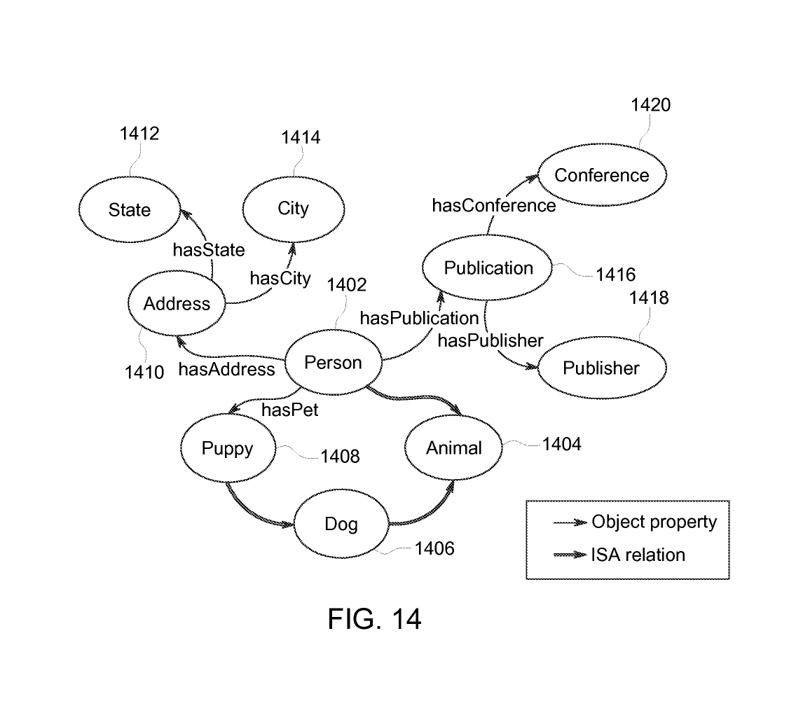

Initially, at S1310, the above-mentioned semantic database is stored in the database unit 122. The semantic database may have a structure that includes relationships among various data classes, in accordance with an ontology. FIG. 14 is a diagram that illustrates a simple example semantic ontology. It will be noted that the diagram of FIG. 14 is in the form of a directed graph. The data classes illustrated for the ontology of FIG. 14 include a “person” data class 1402, an “animal” data class 1404, a “dog” data class 1406, a “puppy” data class 1408, an “address” data class 1410, a “state” data class 1412, a “city” data class 1414, a “publication” data class 1416, a “publisher” data class 1418, and a “conference” data class 1420. The ontology of FIG. 14 also includes the following relationships among classes: An “isA” relationship from class 1402 to class 1404; an “isA” relationship from class 1406 to class 1404; an “isA” relationship from class 1408 to class 1406; a “hasPet” relationship from class 1402 to class 1408; a “hasAddress” relationship from class 1402 to class 1410; a “hasState” relationship from class 1410 to class 1412; a “hasCity” relationship from class 1410 to class 1414; a “hasPublication” relationship from class 1402 to class 1416; a “hasConference” relationship from class 1416 to class 1420; and a “hasPublisher” relationship from class 1416 to class 1418.

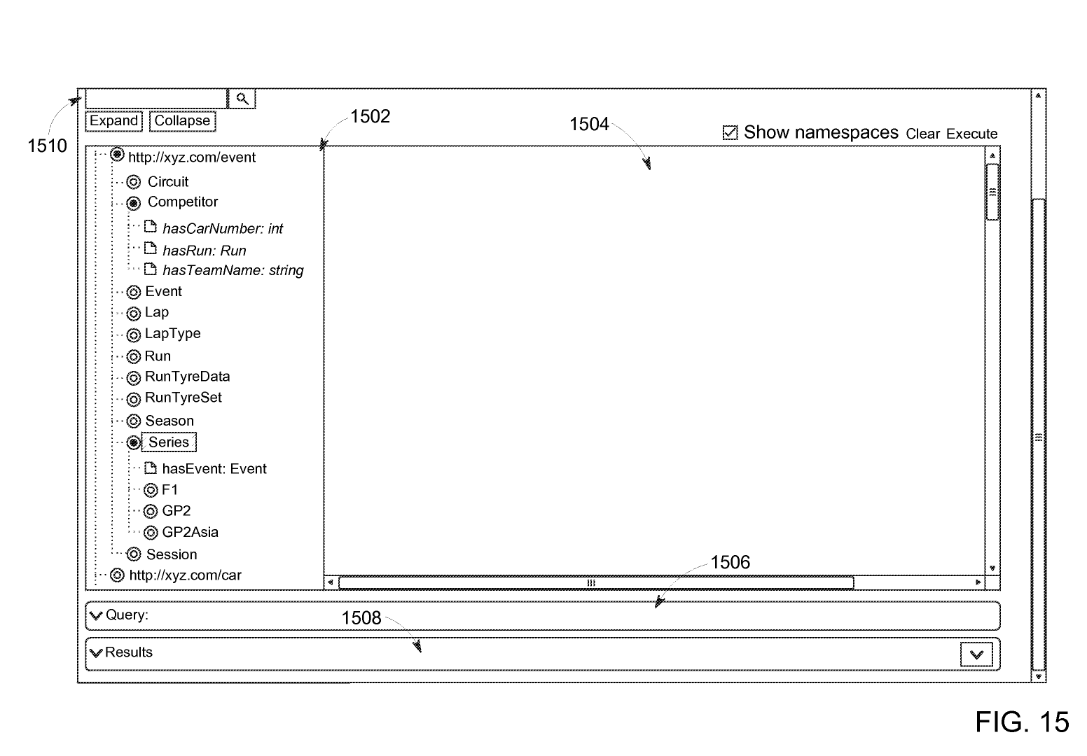

Referring again to FIG. 13, at S1315, a user of the system 100 may invoke the above-mentioned graphically-based tool for automatically generating search queries. The graphically-based query tool may be suitable for use by a domain expert without calling on the assistance of a database design expert. In some embodiments, the user may launch the tool from a menu of software programs available from a computer or terminal In response to the user's action, the system 100, via the interface engine 114 and the display device 110, may display a user interface screen display for the tool, as indicated at S1320 in FIG. 13. An example of such a screen display is shown in FIG. 15.

Referring to FIG. 15, the screen display shown therein includes a class hierarchy section 1502, which displays a hierarchy of data classes for the semantic database that the user wishes to search. That is, the data classes displayed in the class hierarchy section 1502 correspond to data that is stored in the semantic database that the user wishes to search. (It is to be noted that the example semantic database assumed to exist for the screen displays 15, 16 and 18-21 is different from the highly simplified example ontology illustrated in FIG. 14. The example database reflected in FIG. 15 and subsequent screen display drawings is assumed to store data relating to automobile racing operations. The same or a similar semantic database was also assumed to be in use in connection with examples described above in connection with the query customization tool of FIGS. 2-11.) The class hierarchy may be dynamically generated by the system 100 based on the ontology of the semantic data that is to be searched.

In addition, the screen display of FIG. 15 includes a graphical display area 1504 and a query display area 1506. Subsequent drawing figures will show these areas populated with display elements generated by the graphically-based query tool in response to input provided by the user.

Continuing to refer to FIG. 15, the screen display shown therein further includes a results display area 1508, in which the system 100 may display results of database searches produced by applying, to the semantic database, queries generated by the query tool.

Also shown in FIG. 15 as part of the screen display is a search box 1510. The search box 1510 may aid the user in navigating the class hierarchy section 1502 and/or discovering the contents of the class hierarchy section 1502. For example, the user may type input into the search box 1510. If that input corresponds to one or more of the data classes, then the input causes the corresponding data classes to be highlighted in the hierarchy.

The screen window implicit in FIG. 15 does not reveal all the features of the screen display generated by the interface engine 114. Additional features of the screen display will be described with reference to other drawing figures.

Referring again to FIG. 13, at S1325, the user may select two or more data classes from the hierarchy displayed in the class hierarchy section 1502 (FIG. 15). In some embodiments, the user may be permitted to select the classes by (separately) dragging them from the class hierarchy section 1502 into the graphical display area 1504 (FIG. 15). In addition or alternatively, according to other embodiments, the user may be permitted to select the data classes of interest by other types of actions, such as double-clicking on them, by right-clicking on them, etc. It will be appreciated that these actions may be taken by the user operating the pointing device 112 (FIG. 1) to interact with the class hierarchy 1502 (FIG. 15). These actions result in the system receiving data input from the user. The user may decide which two data classes to select according to the type of information that the user wishes to receive from the semantic database. The user's selection of the two data classes may reflect the user's expert understanding of the domain to which the stored data relates, and may for example reflect the two data classes that the user considers to be most relevant to the domain-related subject that the user wishes to explore.

Referring again to FIG. 13, at S1330 the relationships analysis engine 116 (which may be triggered by the interface engine 114) may respond to the data input by the user (i.e., may respond to the selection of the data classes) by analyzing class relationships among the data classes in the semantic database to generate a number of paths through the ontology of the semantic database such that the paths connect selected data classes to each other. That is, as indicated at S1335 in FIG. 13, the relationships analysis engine 116 may generate paths via the relationships in the ontology from one of the two selected data classes to the other. In some embodiments, and/or in some situations, this analysis of the class relationships may generate two, three or more such paths.

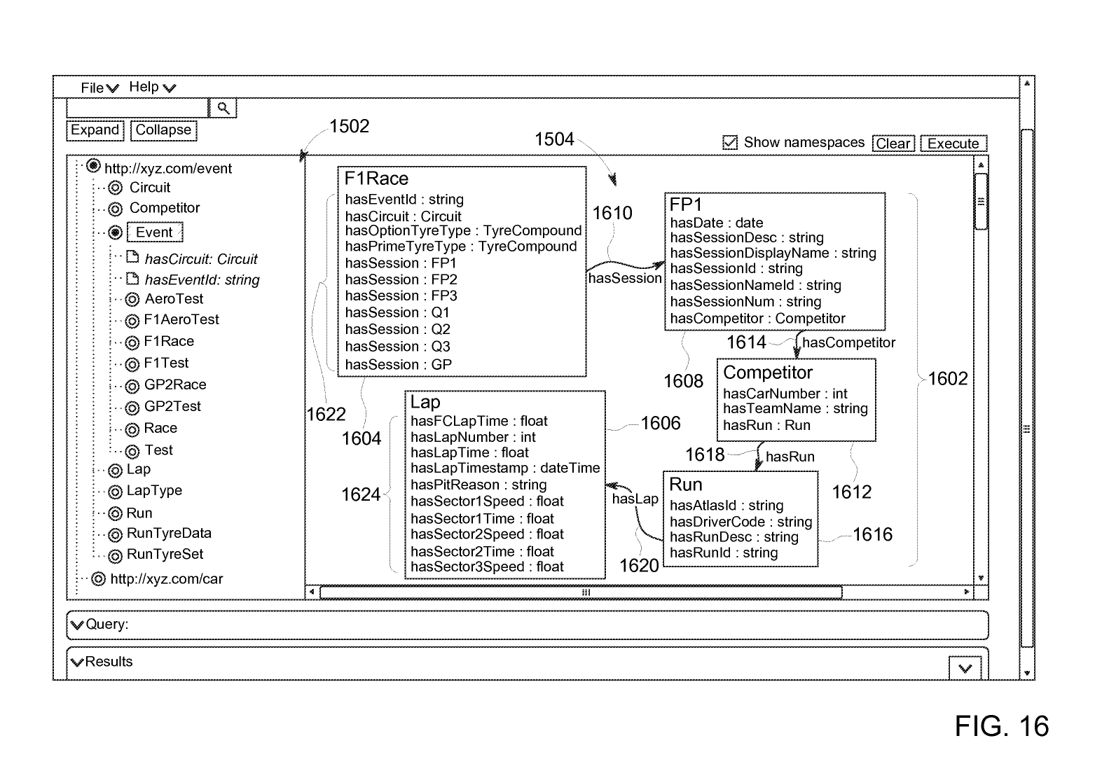

FIG. 16 shows one such path, indicated generally at 1602 in graphical display area 1504. However, in a prior part of the process, not directly illustrated in the screen display drawings, the system 100 may display (via the display device 102 and the interface engine 114) several reduced-size or “thumbnail” representations of the paths generated by the relationships analysis engine 116 at S1335. The user may then be permitted to select one of the reduced-size displayed paths, as indicated at S1340 in FIG. 13. The user may, for example, be permitted to indicate his/her selection of one of the paths by clicking on the path he/she desires to select. This may lead to the system 100 displaying only the selected path, in a screen display like that shown in FIG. 16. It may often be the case that the user will select the path that is the simplest or shortest. In some embodiments, the displaying of multiple paths may be omitted, as well as the user selection, and the system 100 may itself select one of the paths—e.g., the simplest or shortest path. Again in this case, a screen display like that shown in FIG. 16 may then be presented to the user. Automatic selection among multiple paths by the system may be a fixed feature of the system 100, or may be an option that the user may select, perhaps after multiple paths (not shown) have been displayed and the user has elected not to select among the paths himself/herself.

Referring now to FIG. 16, the discussion will now turn to the displayed path 1602. It will be noted that the displayed path 1602 has two end points, namely a block 1604 that corresponds to the “F1Race” data class, and a block 1606 that corresponds to the “Lap” data class. It is to be understood that these two data classes are the classes that the user selected from the class hierarchy section 1502 in the step S1325 referred to above.

It will be noted that the displayed path 1602 includes a block 1608 that corresponds to the “FP1” data class. The relationship-indicating arrow 1610 indicates that there is a “hasSession” relationship from the “F1Race” data class to the “FP1” data class.

The displayed path 1602 further includes a block 1612 that corresponds to the “Competitor” data class. The relationship-indicating arrow 1614 indicates that there is a “hasCompetitor” relationship from the “FP1” data class to the “Competitor” data class.

Still further, the displayed path 1602 includes a block 1616 that corresponds to the “Run” data class. The relationship-indicating arrow 1618 indicates that there is a “hasRun” relationship from the “Competitor” data class to the “Run” data class. Also, the relationship-indicating arrow 1620 indicates that there is a “hasLap” relationship from the “Run” data class (block 1616) to the “Lap” data class (block 1606).

Each of the blocks 1604, 1608, 1612, 1616 and 1606 in displayed path 1602 may also be referred to as a “node”. The endpoint nodes 1604 and 1606 were directly selected by the user; the other nodes were generated by the system 100 in the path-determining step S1335 (FIG. 13) discussed above.

Referring again to FIG. 16, and as indicated, for example, by reference numerals 1622 and 1624, each node also lists attributes of the data class that the node represents.

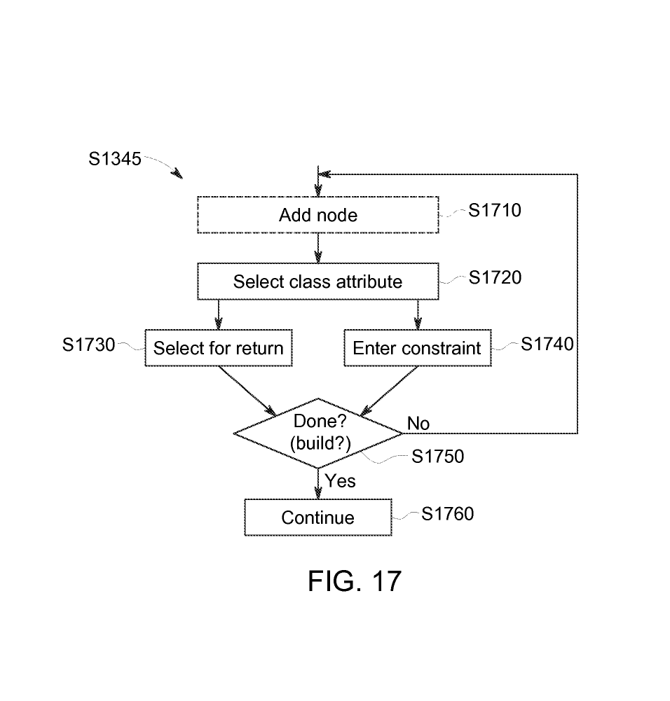

Referring once more to FIG. 13, S1345 represents interactions that the user is permitted to perform with respect to the displayed path 1602 of FIG. 16. FIG. 17 is a flow diagram that shows details of S1345.

Referring to FIG. 17, at S1710 (shown in phantom), in some embodiments, the user may be permitted to interact with the displayed path 1602 by adding further nodes to the displayed path. The initial stage of this step is not explicitly illustrated in the screen display drawing figures, but it may involve the user selecting one or more entries from the class hierarchy shown in class hierarchy section 1502, where the corresponding data classes are not already represented by nodes included in the displayed path 1602. For example, the user may indicate selection of an additional data class by dragging the corresponding entry in the class hierarchy from the class hierarchy section 1502 to the graphical display area 1504. In some embodiments, selection of a further node may also or alternatively be permitted by double-clicking and/or right-clicking the desired entry in the class hierarchy. Selection of an entry from the class hierarchy causes the system 100 to display a new block/node in graphical display area 1504 to represent the newly-selected data class. The system may automatically connect the new node to a previously-existing node based on a relationship that exists in the semantic database ontology between the two corresponding data classes. For example, if the user were to select from the class hierarchy a data class (say “LapNumber”) that corresponds to an attribute/relationship listed in the “Lap” node 1606, then the system will show both the new node (not shown) for the “LapNumber” class and will also show a relationship-indicating arrow (not shown) from the “Lap” node to the new node.

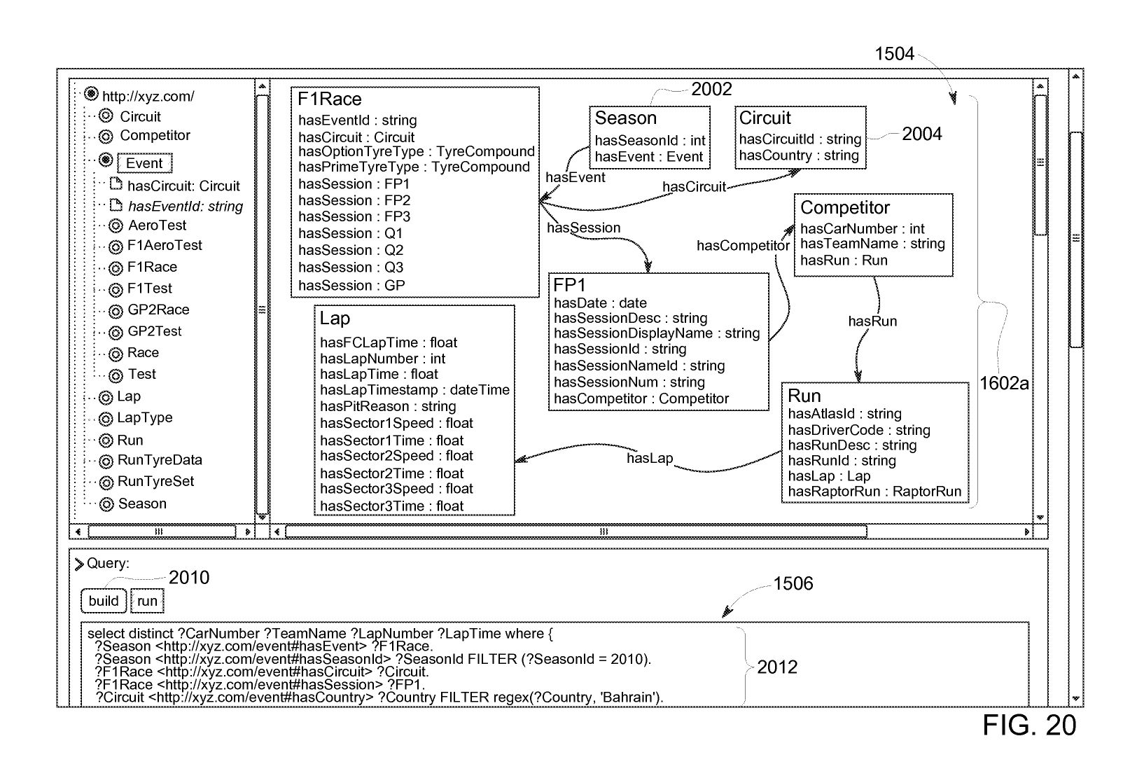

Referring briefly to FIG. 20, the presence of nodes 2002 and 2004 indicates that the user had selected the corresponding class hierarchy entries (“Season” and “Circuit”, respectively) resulting in the updated graphically illustrated path 1602a, shown in the graphical display area 1504 in FIG. 20.

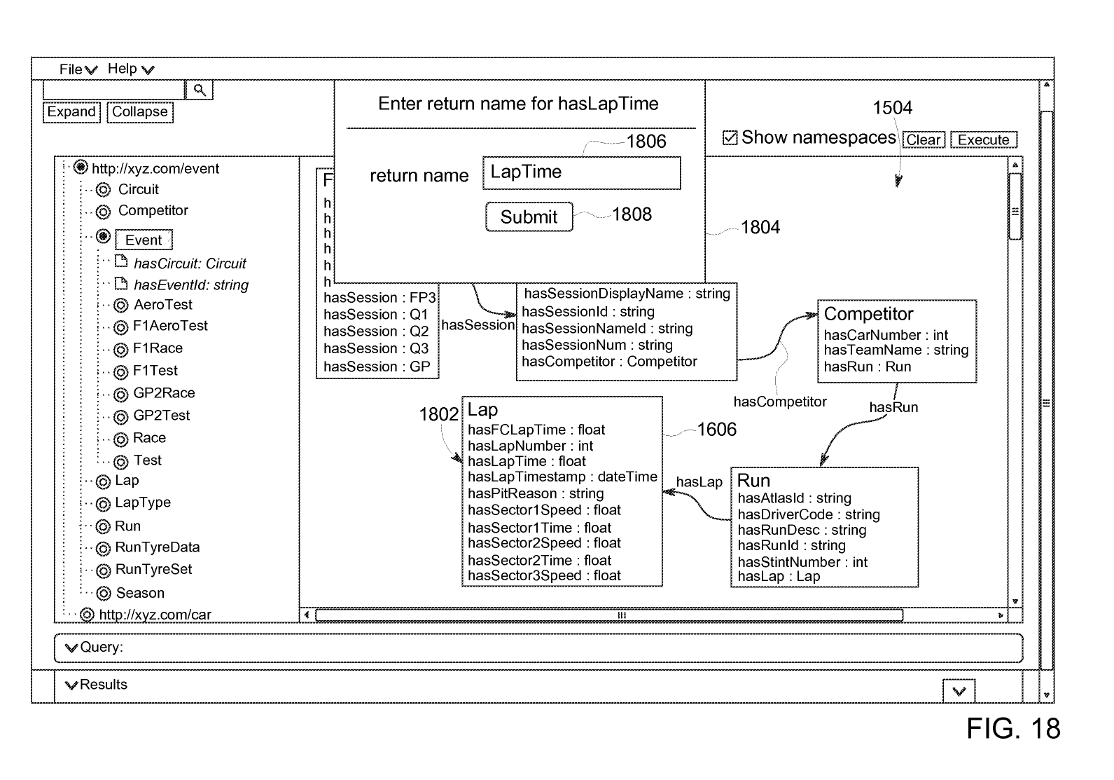

Continuing to refer to FIG. 17, at S1720 the user may interact with one of the nodes in the displayed path 1602 (FIG. 16) by selecting (e.g., clicking on) one of the attributes listed in the node. When the user does so, the interface engine 114 may, e.g., display a menu (not shown) to allow the user to select the type of input he/she wishes to enter concerning the selected attribute. For example, as in S1730 in FIG. 17, the user may indicate selection of the attribute for inclusion in the search results to be obtained by the search query that the user is arranging to have generated. FIG. 18 is a screen display that corresponds to S1730. It is assumed for purposes of FIG. 18 that the user has clicked on attribute 1802 (“hasLapTime”) in node 1606 and has indicated in the resulting menu (not shown) that the attribute is to be included in the search results. As a result, the interface engine 114 has caused the pop-up 1804 to be displayed in association with the graphical display area 1504. The pop-up 1804 allows the user to enter a name (in data entry box 1806) by which the returned search results will indicate the data returned for the selected attribute. In addition, the user can confirm the selection of the attribute for inclusion in the returned results by clicking on the “Submit” button 1808 in the pop-up 1804.

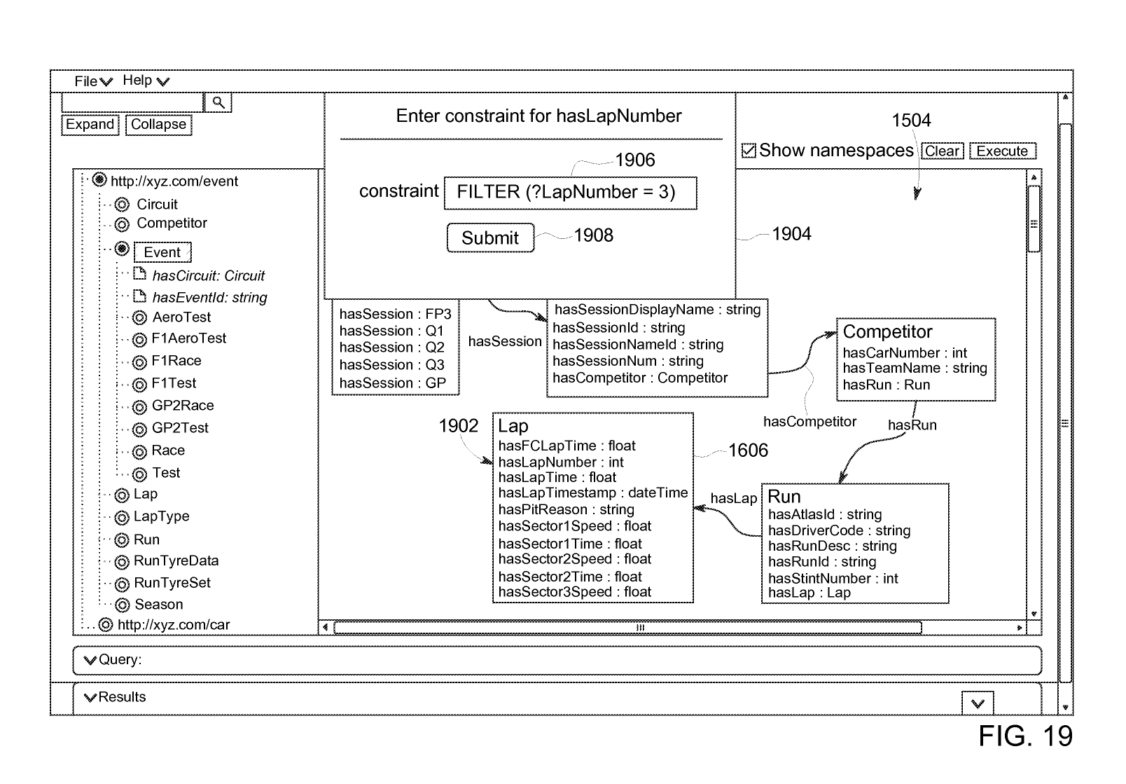

Referring once more to FIG. 17, at 51740 the user may enter data to indicate a constraint that is to be applied to the selected attribute. FIG. 19 is a screen display that corresponds to 51740. It is assumed for purposes of FIG. 19 that the user has clicked on attribute 1902 (“hasLapNumber”) in node 1606 and has indicated in the resulting menu (not shown) that a constraint is to be applied to the attribute in assembling the search results. As a result, the interface engine 114 has caused the pop-up 1904 to be displayed in association with the graphical display area 1504. The pop-up 1904 allows the user to enter data (in a data entry box 1906) to define the constraint on the selected attribute. In this particular example illustrated in FIG. 19, it will be noted that the user has indicated the constraint “LapNumber=3” should be applied. The user can complete the operation of setting the constraint on the selected attribute by clicking on a “Submit” button 1908.

In some embodiments, as described above, the pop-up 1804 or pop-up 1904 may be triggered from a respective entry in a menu (not shown). In addition or alternatively, those pop-ups may in some embodiments be triggered by left-clicking or right-clicking the selected class attribute in question. Other ways of allowing the user to invoke the corresponding functionality may also or alternatively be provided.

In some embodiments, if a menu (not shown) is part of the mechanism for invoking the select-for-return and apply-constraint functions, the menu may include a further option or options. For example, another possible menu option would allow the user to request the system 100 to suggest constraints for the selected class attribute. E.g., for the example data shown, suppose the selected attribute was the “hasTeamName” attribute of the “Competitor” class (node 1612, FIG. 16). In such a case, invoking the “suggest constraint” function may cause the system 100 to display a menu comprising the team names reflected in the database, thereby aiding the user in selecting one of the team names as the constraint for that attribute.

Referring again to FIG. 17, at a decision step 51750, it is determined whether the user has completed providing input (interacting with the displayed path 1602/1602a) to define the desired search query. If not, then the process of FIG. 17 may loop back to one or more of steps S1710, S1720, S1730 and S1740, so that the user is allowed to iteratively perform those steps and the corresponding interactions with the displayed path 1602/1602a to continue defining the desired search query. However, if by clicking on the “build” button 2010 (FIG. 20) the user indicates that he/she has completed the input of data for the search query, then the process of FIG. 17 may advance from decision step S1750 to step S1760, which represents continuation of the process of FIG. 13 from S1345 to S1350.

At S1350 in FIG. 13, the query engine 118 (FIG. 1) is triggered by the interface engine 114 to automatically generate a search query based on format and semantic rules for such queries and based on the data input by the user in connection with the process of FIG. 17. The resulting query may be displayed in the query display area 1506, as indicated at 2012 in FIG. 20. In some embodiments, the system 100 may permit the user to apply text editing to the displayed query 2012 if the user wishes to further modify the query. In addition or alternatively, the GUI may provide an option (not shown) to permit the user to modify the displayed query 2012 by returning to the process of FIG. 17 (i.e., by further interaction with the displayed path 1602/1602a).

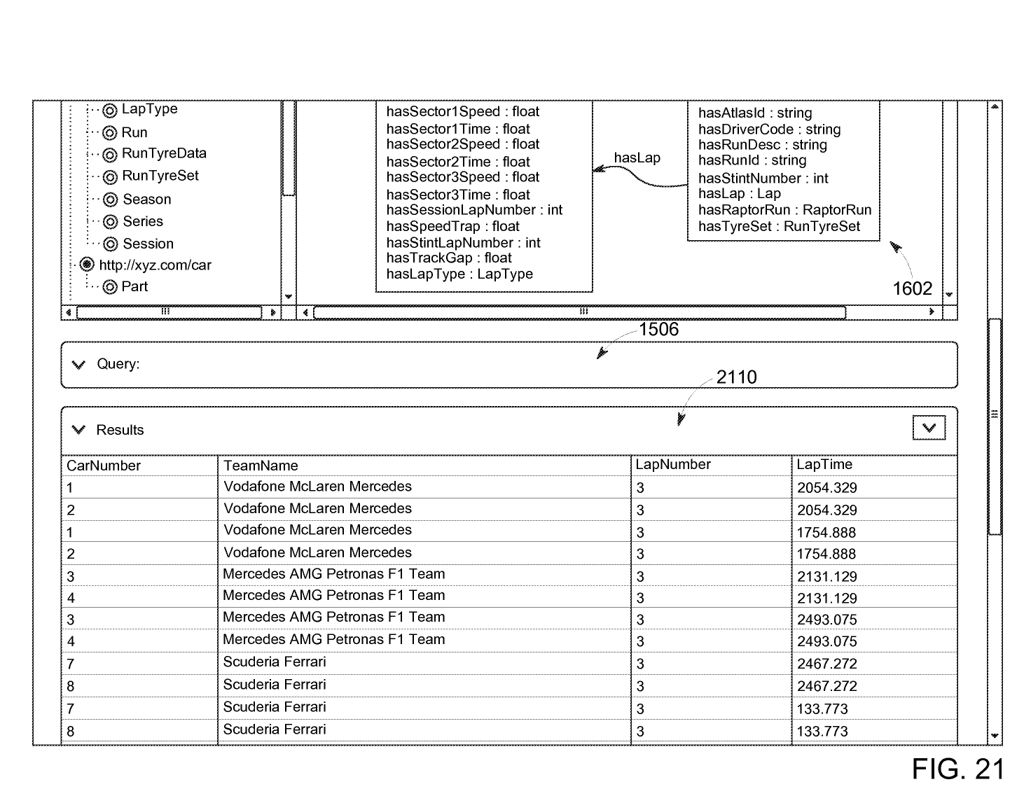

Continuing to refer to FIGS. 13 and 20, if the user is satisfied with the search query as displayed at 2012, he/she has the option of clicking on the “run” button 2014 (FIG. 20) to indicate to the system 100 that he/she wishes that the semantic database be searched on the basis of the search query generated by the query engine 118 (possibly as modified by the user). Upon this action by the user, the process of FIG. 13 advances from S1350 to S1355. At S1355, the search engine 120 executes the search query 2012 with respect to the semantic database. In some embodiments, this operation may be performed in accordance with conventional practices. Then, as indicated at S1360, the system 100 may return the results of the execution of the search query 2012. These results may be displayed per the interface engine 114 and the display device 110. An example of displayed search results is indicated at 2110 in FIG. 21. In some embodiments (though not in the example screen display shown in FIG. 21), the search query that produced the displayed search results 2110 may continue to be displayed in the query display area 1506. In some embodiments, the GUI may present options (not shown) to the user to allow the user to modify the search query by further interaction with the displayed path and/or to initiate an entirely new search by again providing input to lead the system 100 to generate a new search query. In the latter situation, the process of FIG. 13, as described hereinabove, may resume again at S1320 and with the screen display of FIG. 15

The graphically-based query tool described above in connection with FIGS. 13-21 may serve as a useful way of generating the original search query that may be customized by the data-entry-form-based query customization tool of FIGS. 2-12.

The approach represented by the graphically-based search query tool disclosed herein has the benefit of displaying the ontology as expected by the domain experts, while removing artifacts which are not directly relevant to the domain. The tool omits much of the complexity of an RDF (Resource Description Framework) graph, and instead presents what may be called a “domain-range graph”. A domain-range graph may be defined as a graph where the nodes are the concepts in the ontology and there is a directed edge labeled P from concepts C1 to C2 if for some instances a and b of C1 and C2 respectively, P(a,b) would be a valid assertion with respect to the domain and range of P. In other words, there is an edge labeled P from C1 to C2 if C1 is in the domain of P and C2 is in its range. Such graphs may elegantly display the knowledge useful for generating SPARQL queries even in semantic databases built with RDFS (RDF Schema) and OWL (Web Ontology Language) axioms. The path 1602 graphically displayed per FIG. 16 is one example of a domain-range graph.

In some embodiments, while the user is interacting with the displayed path 1602 (FIG. 16) per S1345 of FIG. 13 (and per FIG. 17), the query engine 118 may build test versions of the proposed query according to the user input received to date. The query may test run test versions of the query in background, or may otherwise evaluate the test versions of the query. For example, if the system 100 finds that a test query is likely to involve excessive search time, the system 100 may produce a pop-up or prompt (not shown) to suggest one or more constraints that the user may wish to select to improve the efficiency of the prospective database search. Thus analysis by the system of the query resulting from user input to the graphically-based query tool may aid in producing more effectively rendered queries.

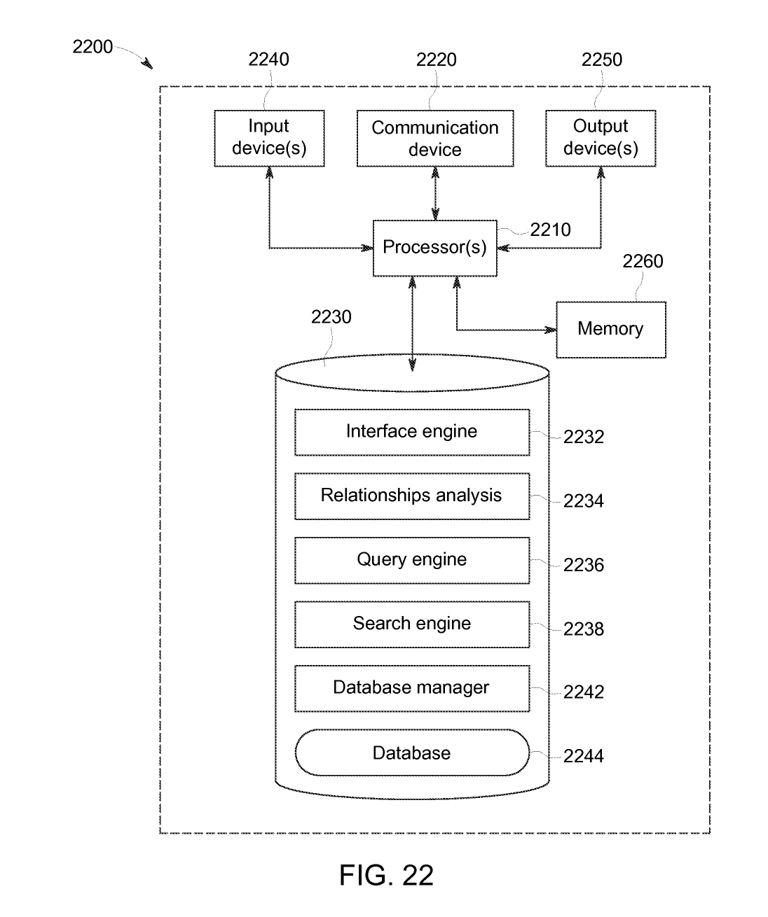

System 2200 shown in FIG. 22 is an example hardware-oriented representation of the system 100 shown in FIG. 1. Continuing to refer to FIG. 22, system 2200 includes one or more processors 2210 operatively coupled to communication device 2220, data storage device 2230, one or more input devices 2240, one or more output devices 2250 and memory 2260. Communication device 2220 may facilitate communication with external devices, such as a reporting client, or a data storage device. Input device(s) 2240 may include, for example, a keyboard, a keypad, a mouse or other pointing device, a microphone, knob or a switch, an infra-red (IR) port, a docking station, and/or a touch screen. Input device(s) 2240 may be used, for example, to enter information into the system 2200. Output device(s) 2250 may include, for example, a display (e.g., a display screen) a speaker, and/or a printer.

Data storage device 2230 may include any appropriate persistent storage device, including combinations of magnetic storage devices (e.g., magnetic tape, hard disk drives and flash memory), optical storage devices, Read Only Memory (ROM) devices, etc., while memory 2260 may include Random Access Memory (RAM).

Data storage device 2230 may store software programs that include program code executed by processor(s) 2210 to cause system 2200 to perform any one or more of the processes described herein. Embodiments are not limited to execution of these processes by a single apparatus. For example, the data storage device 2230 may store a program 2232 that provides functionality corresponding to the interface engine 114 referred to above in connection with FIG. 1.

Data storage device 2230 may also store a software program 2234, which may correspond to the relationships analysis engine 116 referred to above in connection with FIG. 1.

In addition, data storage device 2230 may store a software program 2236, which may correspond to the query engine 118 referred to above in connection with FIG. 1. The query engine may incorporate functionality to implement the data-entry-form based query customization tool and in some embodiments may also incorporate functionality to implement a graphically-based query tool.

Still further, data storage device 2230 may store a software program 2238 which may correspond to the search engine 120 referred to above in connection with FIG. 1.

Also, data storage device 2230 may store a semantic database manager program 2242 and a semantic database 2244, which together may constitute the database unit 122 referred to above in connection with FIG. 1. Data storage device 2230 may store other data and other program code for providing additional functionality and/or which are necessary for operation of system 2200, such as device drivers, operating system files, etc.

A technical effect is to provide improved efficiency in searching semantic databases.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

In some embodiments, the search query generation tool may include additional features besides those described above. For example, the user may be provided options to change the order of columns in the reported results, to reorder the rows and/or to limit the number of rows returned. According to other features that may be provided, the user may have the opportunity to save sub-queries or to collapse sub-queries into a single display unit so that an inner join query can be built. In some embodiments, the interface engine may automatically collapse nodes in the illustrated paths where values are not being returned for those nodes; a purpose of this feature may be to save display space.

Embodiments described herein are solely for the purpose of illustration. A person of ordinary skill in the relevant art may recognize other embodiments may be practiced with modifications and alterations to that described above.

What is claimed is:

1. A method, comprising:
storing a database search query for searching a semantic database, the database search query including references to a plurality of data classes that correspond to data stored in the semantic database, the database search query including a plurality of filter values and a plurality of return variables;
storing relationship data in association with the stored database search query, the relationship data indicative of relationships among data classes included in said plurality of data classes;
automatically generating a data entry form that includes (a) a respective data entry mechanism that corresponds to each filter value included in the stored database search query; and (b) a respective data display column that corresponds to each return variable; and
automatically generating a respective set of permissible input values for each of said data entry mechanisms.

2. The method of claim 1, wherein:
said step of generating a respective set of permissible values for each of said data entry mechanisms includes:
for a given one of said data entry mechanisms, selecting the corresponding filter value;
determining a filter parameter that corresponds to the selected filter value;
modifying the database search query by designating the determined filter parameter as a sole return variable for the search query; and
performing a trial execution of the modified database search query to produce trial search results, the trial search results constituting said set of permissible values.

3. The method of claim 2, wherein said trial execution of the modified database search query occurs after a user has entered a respective selected value using at least one of said data entry mechanisms, said modified database search query including said at least one respective selected value as a constraint for said trial execution of said modified database search query.

4. The method of claim 1, further comprising:
allowing a user to enter a respective input value into each data entry mechanism included in the data entry form;
automatically generating a new database search query based on the input values entered by the user;
executing the new database search query with respect to the semantic database; and
returning to the user results of executing the new database search query.

5. The method of claim 1, wherein:
at least one of the data entry mechanisms is a menu.

6. The method of claim 5, wherein:
each of the filter values corresponds to a respective filter parameter; and
the menu includes a plurality of menu items which consist of the members of a respective set of permissible input values generated with respect to a corresponding filter parameter.

7. The method of claim 1, further comprising, before the search-query storing step:
generating the search query automatically based on user interaction with a graphical display of relationships among at least some of said plurality of data classes.

8. The method of claim 1, further comprising, before the relationship-data storing step:
automatically parsing the stored database search query to automatically generate said relationship data.

9. The method of claim 1, further comprising:
updating the respective set of permissible input values in response to changes in the data stored in the semantic database.

10. The method of claim 1, further comprising:
selecting among types of data entry mechanisms based on results of said step of automatically generating sets of permissible input values.

11. The method of claim 10, wherein said types of data entry mechanisms include:
(a) a menu; and (b) a free-form data entry field.

12. The method of claim 11, wherein:
one of said data entry mechanisms is selected to be a free-form data entry field;
the method further comprising:
based on the generated set of permissible input values for said one of said data entry mechanisms, determining a type of the permissible entries; wherein the determined type is selected from the group consisting of (a) a numeric input value; and (b) a string input value.

13. The method of claim 12, further comprising:
receiving an input value in said free-form data entry field selected for said one of said data entry mechanisms; and
based on the generated set of permissible input values for said one of said data mechanisms, determining whether said received input value is permissible.

14. The method of claim 1, wherein the step of automatically generating the data entry form includes analyzing the stored database search query.

15. A method, comprising:
selecting at least two data classes that correspond to data stored in a semantic database;
displaying at least one graphically illustrated path that reflects class relationships among said selected data classes in the semantic database;
automatically generating a first database search query based on interactions by a user with the displayed graphically illustrated path; the first search query including a plurality of filter values; each of said filter values instantiating a respective filter parameter; the first search query also including a plurality of return values;
automatically generating a respective set of permissible input values for each of the filter parameters;
automatically generating a data entry form by analyzing the first search query, the data entry form including:
a menu corresponding to a first one of the filter parameters; the menu listing all members of the generated set of permissible input values for said first one of the filter parameters; the menu for permitting a user to select one of said set of permissible input values as a constraint value for said first one of the filter parameters;
a free-form data entry field for receiving user input to specify a constraint value for a second one of the filter parameters;
a first column that corresponds to a first one of the return variables; and
a second column that corresponds to a second one of the return variables;
receiving user input via the menu and the free-form data entry field to specify (a) the constraint value for said first one of the filter parameters; and (b) the constraint value for said second one of the filter parameters;
automatically modifying the first search query based on the specified constraint values to form a second database search query, the second database search query including the specified constraint values as constraints;
executing the second database search query with respect to the semantic database;
returning results of executing the second database search query; and
displaying the returned results in the first and second columns of the data entry form.

16. The method of claims 15, wherein the step of automatically generating sets of permissible input values includes trial executions of modified versions of the first database search query.

17. The method of claim 15, further comprising:
confirming that the received user input via the free-form data entry field matches a member of the set of permissible input values for the second one of the filter parameters.

18. An apparatus, comprising:
a processor; and
a memory in communication with the processor, the memory storing program instructions, the processor operative with the program instructions to perform functions as follows:
storing a database search query for searching a semantic database, the database search query including references to a plurality of data classes that correspond to data stored in the semantic database, the database search query including a plurality of filter values and a plurality of return variables;
storing relationship data in association with the stored database search query, the relationship data indicative of relationships among data classes included in said plurality of data classes;
automatically generating a data entry form that includes (a) a respective data entry mechanism that corresponds to each filter value included in the stored database search query; and (b) a respective data display column that corresponds to each return variable; and
automatically generating a respective set of permissible input values for each of said data entry mechanisms.

19. The apparatus of claim 18, wherein the processor is further operative with the program instructions to perform the following functions:
allowing a user to enter a respective input value into each data entry mechanism included in the data entry form;
automatically generating a new database search query based on the input values entered by the user;
executing the new database search query with respect to the semantic database; and
returning to the user results of executing the new database search query.

20. The apparatus of claim 18, wherein:
said function of generating a respective set of permissible values for each of said data entry mechanisms includes:
for a given one of said data entry mechanisms, selecting the corresponding filter value;
determining a filter parameter that corresponds to the selected filter value;
modifying the database search query by designating the determined filter parameter as a sole return variable for the search query; and
performing a trial execution of the modified database search query to produce trial search results, the trial search results constituting said set of permissible values.
